(19) United States
(12) Patent Application Publication
(10) Pub. No.: US 2017/0321791 A1
(43) Pub. Date: Nov. 9, 2017

(54) Actuating Device For Actuating A Cable

(71) Applicant: Kongsberg Automotive AB, Mullsjö (SE)

(72) Inventor: Frank Dankbaar, Mullsjö (SE)

(21) Appl. No.: 15/524,755

(22) PCT Filed: Nov. 7, 2014
(86) PCT No.: PCT/IB2014/065882

§ 371 Date: May 5, 2017

(51) Int. Cl. F16H 49/00; F16C 1/12; H02K 7/116; B60N 2/20

(52) U.S. Cl. CPC F16H 49/001; H02K 7/116; F16C 1/12; B60N 2/20

(57) ABSTRACT

The invention provides an actuating device for actuating a cable. The actuating device comprises a housing defining an interior and a motor assembly including a shaft. The actuating device also comprises at least two planetary gears and a flex gear having an inner surface and an outer surface with the inner surface partially engaged with the planetary gears. The actuating device additionally comprises an output member having a drive portion and a mounting interface with the drive portion engaged with a section such that the output member is rotatable relative to the housing when the shaft rotates. The actuating device additionally comprises a connector coupled to the mounting interface for securing the cable to the mounting interface. The connector moves relative to the housing and in unison with the output member during the rotation of the output member for activating the cable during operation of the actuating device.

### BACKGROUND OF THE INVENTION

### 1. Field of the Invention

The present invention generally relates to an actuating device for actuating a cable.

### 2. Description of the Related Art

Various actuating devices have been developed for actuating, releasing, moving, and/or adjusting various components. For example, actuating devices may be utilized in various environments, such as vehicle interiors. Actuating devices may be utilized to provide for powered releasing of locks, latches, and/or other similar components. Actuating devices may be located at a distance away from the lock, latch, and/or other similar component. A cable may be utilized to couple the actuating device to the lock, latch, and/or other similar component.

### SUMMARY OF THE INVENTION AND ADVANTAGES

The invention provides an actuating device for actuating a cable. The actuating device comprises a housing defining an interior and a motor assembly including a shaft with the motor assembly disposed within the interior of the housing. The actuating device also comprises at least two planetary gears disposed within the interior of the housing with the at least two planetary gears coupled to the motor assembly. The actuating device further comprises a flex gear disposed within the interior of the housing with the flex gear having an inner surface and an outer surface with the inner surface partially engaged with the planetary gears. The actuating device additionally comprises an output member at least partially disposed within the interior of the housing. The output member has a drive portion and a mounting interface with the drive portion engaged with a section of the outer surface of the flex gear such that the output member is rotatable relative to the housing when the shaft of the motor assembly rotates. The actuating device additionally comprises a connector coupled to the mounting interface of the output member for securing the cable to the mounting interface with the connector moving relative to the housing and in unison with the output member during the rotation of the output member for activating the cable during operation of the actuating device.

The invention further provides an actuating device for actuating a cable. The actuating device comprising a housing defining an interior and a motor assembly including a shaft with the motor assembly disposed within the interior of the housing. The actuating device also comprises a gear system disposed within the interior of the housing with the gear system coupled to the motor assembly. The actuating device further comprises an output member at least partially disposed within the interior of the housing with the output member engaged with the gear system and rotatable relative to the housing during operation of the motor assembly. The actuating device additionally comprises a cable having a conduit and a core wire moveable within the conduit between a retracted position and an extended position with the core wire having first and second opposing ends. The actuating device also comprises a connector coupled to the output member with the first end of the cable coupled to the connector and moveable 360 degrees during the rotation of the output member to define an actuating cycle with the connector having a first location corresponding to the retracted position of the core wire and a second location corresponding to the extended position of the core wire with the first location approximately 180 degrees from the second location with the core wire moving between the retracted and the extended positions during said actuating cycle.

### BRIEF DESCRIPTION OF THE DRAWINGS

Other advantages of the present invention will be readily appreciated, as the same becomes better understood by reference to the following detailed description when considered in connection with the accompanying drawings.

FIG. 1 is a perspective view of the actuating device.

FIG. 2 is an exploded view of the actuating device.

FIG. 3 is a cross-sectional view of the actuating device.

FIG. 4 is a top perspective view of the actuating device with a first half of a housing removed and a mounting interface of an output member removed.

FIG. 5 is a perspective view of the actuating device with the first half of the housing shown in phantom and a second half of the housing shown in phantom.

FIG. 6 is a side perspective view of the actuating device with both halves of the housing shown in phantom.

FIG. 7 is a perspective view of a flex gear.

FIG. 8 is a bottom perspective view of the actuating device with the second half of the housing removed.

FIG. 9 is a perspective view of the actuating device with a cable removed, the first and second halves of the housing removed, and the mounting interface removed.

FIG. 10 is a top view of the actuating device with the cable in an extended position.

FIG. 11 is a top view of the actuating device with output member rotated 90 degrees from the extended position.

FIG. 12 is a top view of the actuating device with the output member rotated 180 degrees from the extended position and with the cable in a retracted position.

FIG. 13 is a top view of the actuating device with the output member rotated 270 degrees from the extended position.

### DETAILED DESCRIPTION OF THE INVENTION

With reference to the Figures, wherein like numerals indicate like parts throughout the several views, an actuating device 20 for actuating a cable is shown. The actuating device 20 is typically used in a vehicle for actuating a lock, a latch, or another similar component. The vehicle may include a seat having a seat bottom and a backrest extending from the seat bottom. The lock, the latch, or the other similar component is typically coupled to the seat used to release a seat-back latch. Typically, releasing the seat-back latch actuates a vehicle seat from an upward position to a stowage position. More specifically, the vehicle seat may have a seat bottom and a backrest with the backrest collapsing toward the seat bottom when the actuating device actuates the cable.

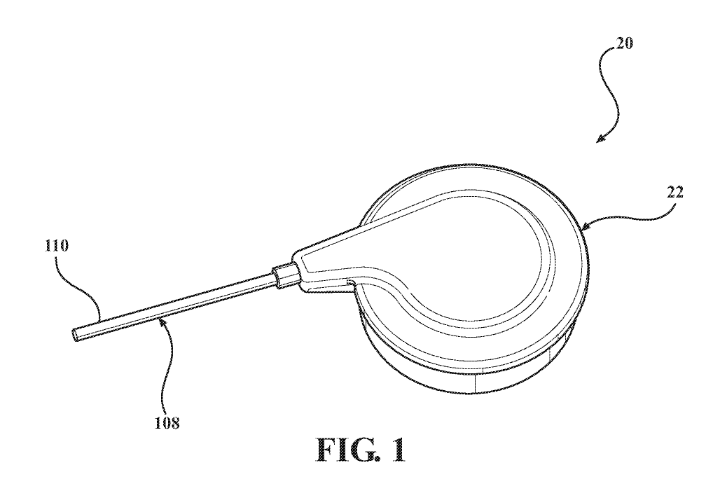

With reference to FIGS. 1-3, the actuating device 20 includes a housing 22 defining an interior. The housing 22 defines an aperture 24 with the aperture 24 extending outwardly from the interior of the housing 22. The actuating device 20 also includes a motor assembly 26 disposed within the interior of the housing 22. In one embodiment of the invention, and as shown throughout the Figures, the motor assembly 26 is a pancake motor. Pancake motors, as known in the art, provide for a compact motor assembly having a high power density and a high gear ratio, which provides the pancake motor with high torque due a high number of gear teeth being engaged. Pancake motors also reduce backlash and allow for rapid start-stop times. It is to be appreciated that the motor assembly 26 may be any type of motor without departing from the nature of the present invention. It is to be appreciated that the motor assembly 26 may have an axial oriented magnetic field or a radial oriented magnetic field without departing from the nature of the present invention.

The actuating device 20 also includes a casing 28 having an interior with the casing 28 disposed within the interior of the housing 22. The motor assembly 26 is disposed within the interior of the casing 28. The casing 28 defines a hole 30. The motor assembly 26 further includes a rotor 32, a flux plate 34, and a printed circuit board 36 disposed within the interior of the casing with the printed circuit board 36 disposed between the rotor 32 and the flux plate 34. More specifically, the rotor 32, the flux plate 34, and the printed circuit board 36 are disposed adjacent one another with the rotor 32 disposed between the printed circuit board 36 and the casing 28, and with the flux plate 34 disposed between the housing 22 and the printed circuit board 36.

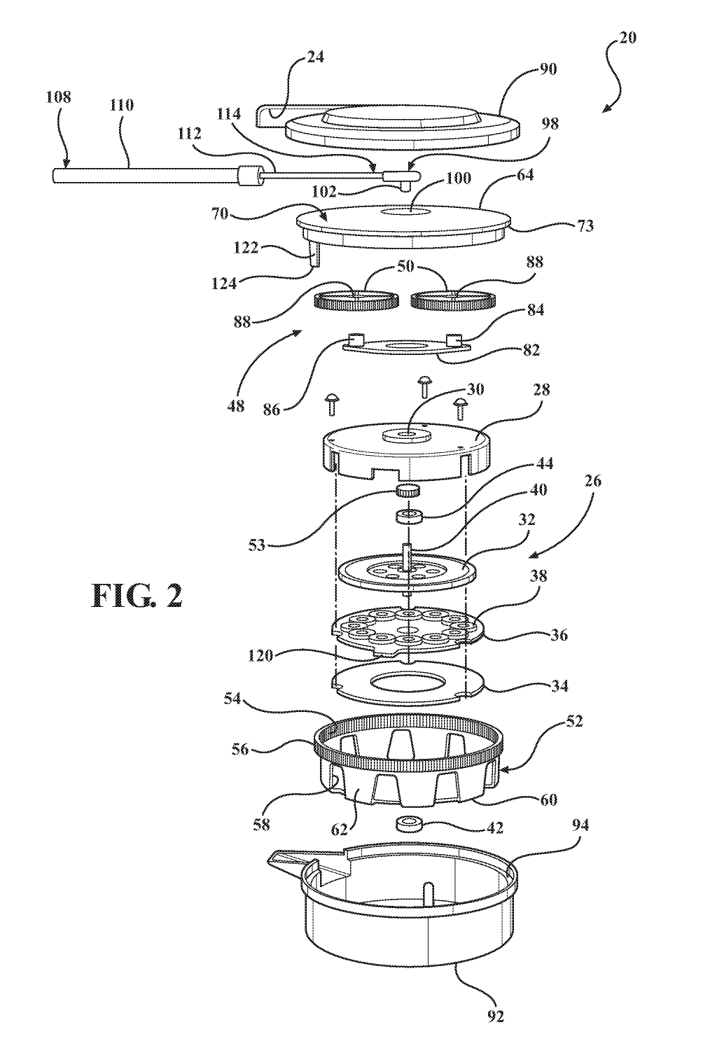

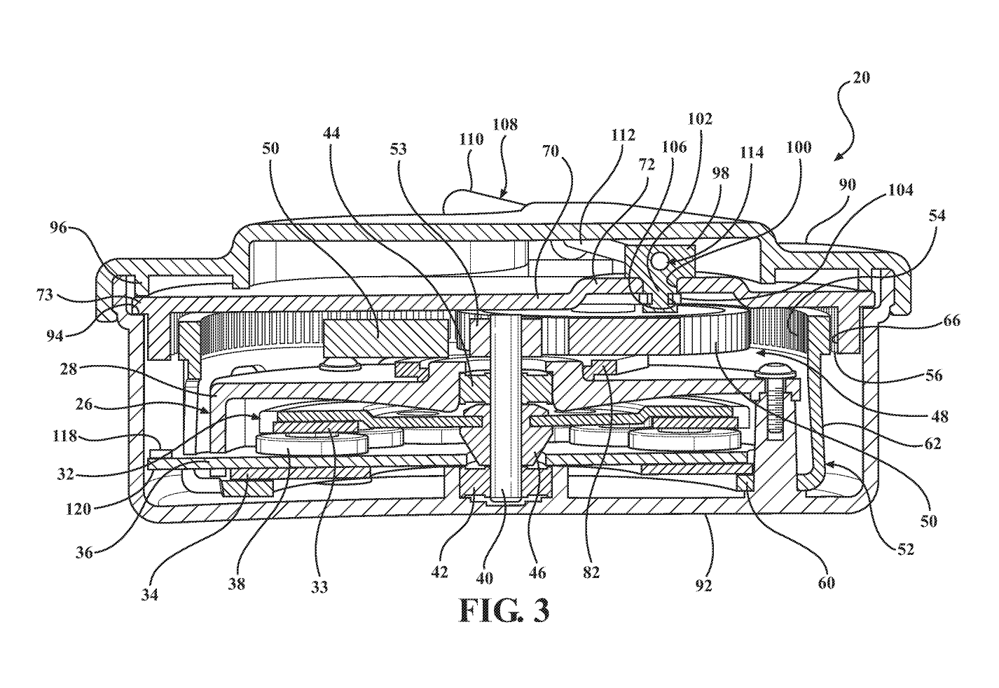

The rotor 32 has a plurality of alternatively polarized magnets 33. The printed circuit board 36 has a plurality of coils 38, as best shown in FIGS. 2 and 3. The plurality of coils 38 creates a magnetic field when supplied with a current, which, in turn, causes the rotor 32 to rotate, as described in further detail below. The flux plate 34 concentrates the magnetic field created by current in the plurality of coils 38 of the printed circuit board 36. The concentration of the magnetic field causes a stronger magnetic field to be created around the rotor 32 in order to cause the rotor 32 to rotate with respect to the housing due to the plurality of alternatively polarized magnets 33.

The motor assembly 26 includes a shaft 40. In one embodiment, the shaft 40 extends from the housing 22 through the hole 30 of the casing 28. The shaft 40 is coupled to the rotor 32 of the motor assembly 26. The motor assembly further includes a first bearing 42 and a second bearing 44. The first bearing 42 abuts the printed circuit board 36 and is coupled to the shaft 40. The second bearing 44 abuts the casing 28 and is coupled to the shaft 40. The motor assembly also includes a coupler 46 disposed within the interior of the casing 28. The coupler 46 is mounted to and disposed between the rotor 32 and the shaft 40 such that rotation of the rotor 32 transmits rotational motion to the shaft 40 during operation of the actuating device 20. More specifically, the rotor 32, the coupler 46, and the shaft 40 rotate in unison when current is supplied to the plurality of coils 38.

In one embodiment, the actuating device 20 includes a gear system 48 disposed within the interior of the housing 22 with the gear system 48 coupled to the motor assembly 26. The gear system 48 translates rotational motion from the motor assembly 26 to actuate the seat-back latch, as described in further detail below. The gear system 48 may comprise of any arrangement of gears without departing from the nature of the present invention.

In another embodiment, the gear system 48 is further defined as including at least two planetary gears 50, a flex gear 52, and an output member 64. The planetary gears 50 are disposed within the interior of the housing 22. The planetary gears 50 are coupled to the motor assembly 26 such that rotational motion is translated from the motor assembly 26 to the planetary gears 50, as described in further detail below. The gear system 48 also includes a pinion 53 engaged with the planetary gears 50. The pinion 53 is coupled to the shaft 40 of the motor assembly 26 such that the pinion 53 translates rotational motion to the planetary gears 50 from the shaft 40.

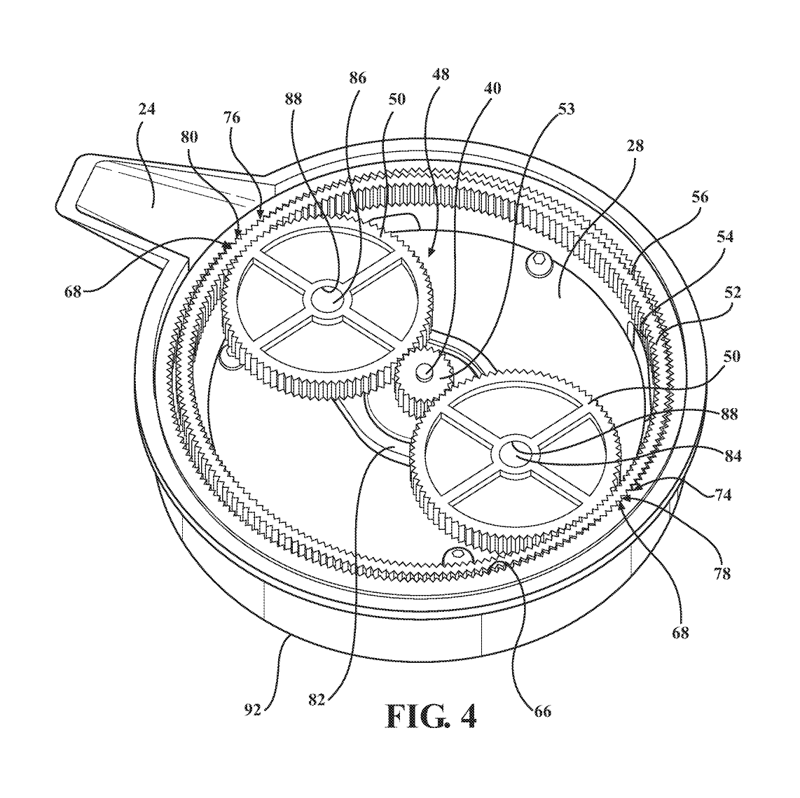

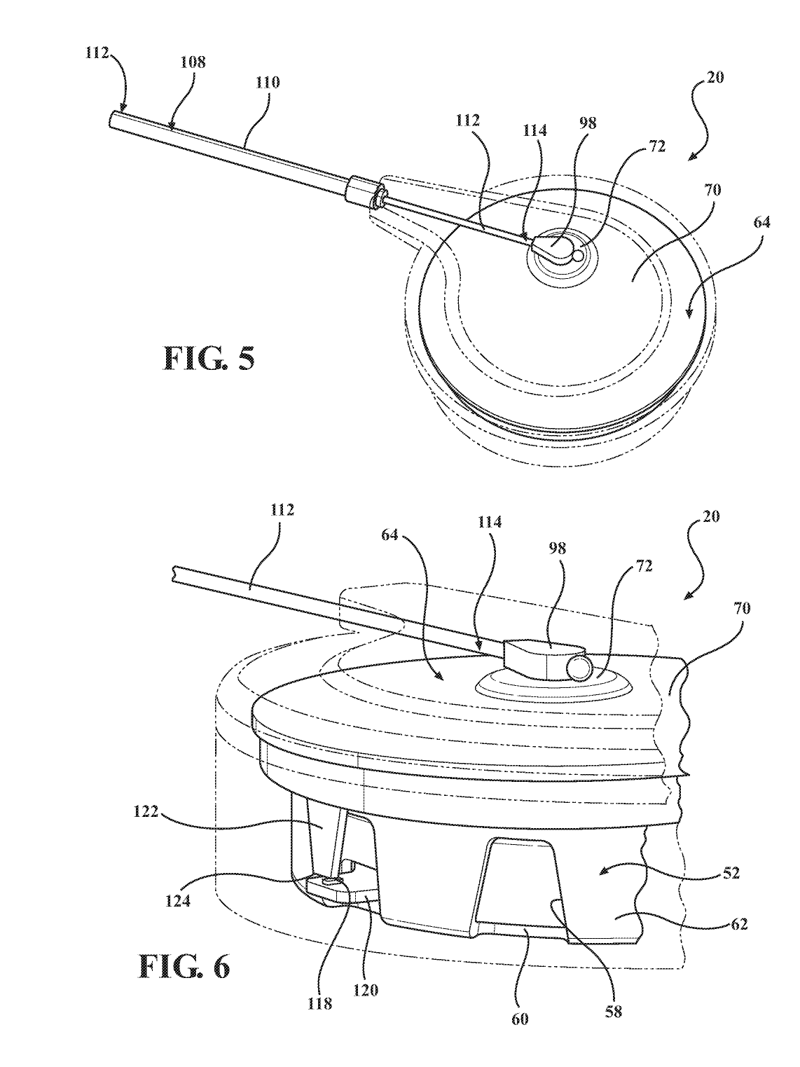

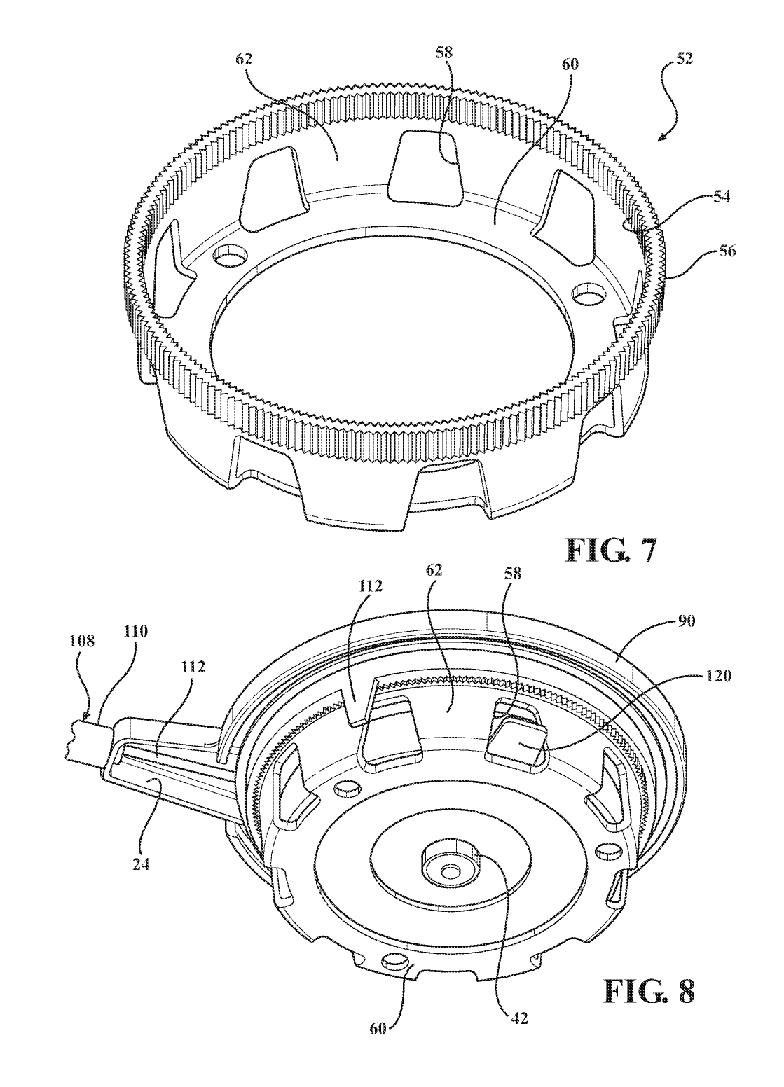

The flex gear 52 is disposed within the interior of the housing 22. The flex gear 52 has an inner surface 54 and an outer surface 56 with the inner surface 54 partially engaged with the planetary gears 50, as best shown in FIG. 4. The flex gear 52 is made of an elastically deformable material. The flex gear 52 defines a plurality of voids 58. The plurality of voids 58 of the flex gear 52 reduce the overall weight of the flex gear 52, which, in turn, reduces the overall weight of the actuating device 20. The flex gear 52 has a base 60 and a gear wall 62. The base 60 of the flex gear 52 is rigidly fixed to the housing 22 such that the flex gear 52 does not rotate with respect to the housing 22 during rotation of the shaft 40 of the motor assembly 26.

The gear wall 62 of the flex gear 52 has a rest state and an engaged state. The rest state of the gear wall 62 occurs when the gear wall 62 is disengaged from the planetary gears 50. The engaged state occurs when the gear wall 62 is engaged with the planetary gears 50. When the gear wall 62 of the flex gear 52 is in the engaged state, the gear wall 62 has a first diameter. When the gear wall 62 of the flex gear 52 is in the rest state, the gear wall has a second diameter. The second diameter of the gear wall 62 of the flex gear 52 is greater than the first diameter. As shown throughout the Figures, the gear wall 62 of the flex gear 52 is in the engaged state such that the gear wall 62 defines the second diameter. Due to internal stress of the elastically deformable material, the gear wall 62 of the flex gear 52 returns to the rest state when the planetary gears 50 are removed from the actuating device 20.

The output member 64 is at least partially disposed within the interior of the housing 22. The output member 64 has a drive portion 66 engaged with a section 68 of the outer surface 56 of the flex gear 52 such that the output member 64 is rotatable relative to the housing 22 when the shaft 40 of the motor assembly 26 rotates. The output member 64 also has a mounting interface 70. The mounting interface 70 has a segment 72 elevated toward the housing 22. The output member also has a ledge 73 extending from the mounting interface 70 about a perimeter of the drive portion 66.

As best shown in FIG. 4, the inner surface 54 of the flex gear 52 is further defined as a first area 74 and a second area 76. The second area 76 is approximately 180 degrees from the first area 74 along the inner surface 54. When the gear wall 62 of the flex gear 52 is in the engaged state, one of the planetary gears 50 is engaged with the first area 74 and the other one of the planetary gears 50 is engaged with the second area 76. The section 68 of the outer surface 56 of the flex gear 52 is further defined as a first section 78 and a second section 80. The first section 78 and the second section 80 are approximately 180 degrees apart from one another along the outer surface 56 of the flex gear 52. The first area 74 of the flex gear 52 corresponds to the first section 78 of the outer surface 56, and the second area 76 corresponds to the second section 80 of the outer surface 56. Furthermore, both the first section 78 and the second section 80 of the outer surface 56 are engaged with the drive portion 66 of the output member 64. The engagement of the first section 78 and the second section 80 with the drive portion 66 defines the second diameter such that the gear wall 62 of the flex gear 52 remains in the engaged state during the operation of the actuating device 20.

In order to help secure the planetary gears 50 with respect to the housing 22, the actuating device 20 also includes a gear retainer 82 disposed within the interior of the housing 22. Each of the planetary gears 50 are mounted to the gear retainer 82 such that each of the planetary gears 50 are rotatable relative to the housing 22 about the inner surface 54 of the flex gear 52 when the shaft 40 of the motor assembly 26 rotates. The gear retainer 82 abuts the casing 28. The gear retainer 82 has a first cylinder 84 and a second cylinder 86 with the first cylinder 84 and the second cylinder 86 aligned linearly with the pinion 53. Each of the planetary gears 50 define an opening 88 such that the first cylinder 84 extends through one of the openings 88 and the second cylinder 86 extends through the other one of the openings 88. During operation of the actuating device 20, one of the planetary gears 50 rotates about the first cylinder 84 and the other of the planetary gears 50 rotates about the second cylinder 86. It is to be appreciated that the actuating device 20 may contain two or more planetary gears 50 without departing from the nature of the present invention. It is also to be appreciated that the gear retainer 82 may comprise zero or any number of cylinders without departing from the nature of the present invention.

The planetary gears 50 have first plurality of teeth, the outer surface 56 of the flex gear 52 has a second plurality of teeth, and the drive portion 66 of the output member 64 has a third plurality of teeth. The second plurality of teeth is greater than the first plurality of teeth and the third plurality of teeth is greater than the second plurality of teeth. The different plurality of teeth of the outer surface 56, the flex gear 52, and the drive portion 66 provides the gear system 48 with a high gear ratio.

To help with assembly and disassembly of the actuating device 20, the housing may be further defined as a first half 90 of the housing 22 and a second half 92 of the housing 22 with the first half 90 of the housing 22 coupled to the second half 92 of the housing 22 to define the interior. More specifically, the first half 90 of the housing 22 is adjacent the output member 64, and the second half 92 of the housing 22 is adjacent the flex gear 52. The second half 92 of the housing 22 has a shelf 94, and the first half 90 of the housing 22 has a protrusion 96 extending toward the shelf 94. The ledge 73 of the output member 64 is disposed between the shelf 94 of the second half 92 of the housing 22 and the protrusion 96 of the first half 90 of the housing 22. Since the ledge 73 of the output member 64 is disposed between the shelf 94 of the second half 92 of the housing 22 and the protrusion 96 of the first half 90 of the housing 22, during operation of the actuating device 20 the output member 64 rotates with respect to the housing 22 with the ledge 73 remaining disposed and sliding between the shelf 94 of the second half 92 of the housing 22 and the protrusion 96 of the first half 90 of the housing 22.

In another embodiment, the actuating device 20 further includes a connector 98 coupled to the mounting interface 70 of the output member 64 for securing the cable to the mounting interface 70. The connector 98 moves relative to the housing 22 and in unison with the output member 64 during rotation of the output member 64 for activating the cable during operation of the actuating device 20. More specifically, the connector 98 is coupled to the segment 72 of the mounting interface 70. The connector 98 is pivotably coupled to the mounting interface 70 of the output member 64. More specifically, the segment 72 of the mounting interface 70 defines a cavity 100, and the connector 98 has a projection 102 extending through the cavity 100 for connecting the cable to the mounting interface 70 of the output member 64. The connector 98 is coupled to the segment 72 of the mounting interface 70 by a clip 104, as best shown in FIGS. 3 and 6.

The projection 102 the connector 98 defines a groove 106, and the clip 104 is partially disposed within the groove 106 for securing the cable to said mounting interface 70 of the output member 64. It is to be appreciated that the connector 98 may be coupled to the segment 72 of the mounting interface 70 in any other suitable manner without departing from the scope of the present invention. In this embodiment, the drive portion 66 is engaged with the gear system 48 and the connector 98 is coupled to the mounting interface 70. The gear system translates rotational motion of the motor assembly 26 to the output member 64. The gear system may be any suitable arrangement of gears, sprockets, spur gears, straight-cut edge gears, helical (dry fixed) gears, double helical gears, bevel gears, planetary gears, harmonic gears, or the like without departing from the nature of the present invention.

In one embodiment, the actuating device 20 includes a cable 108 having a conduit 110 and a core wire 112. The core wire 112 is moveable within the conduit 110 between a retracted position and an extended position. The retracted position and the extended position of the core wire 112 are described in further detail below. The core wire 112 has a first end 114 and a second end 116 opposite the first end 114. The connector 98 is coupled to the output member 64 and the first end 114 of the core wire 112 is coupled to the connector 98. The connector 98 is moveable 360 degrees during rotation of the output member 64 to define an actuating cycle. In the actuating cycle, the connector 98 has a first location corresponding to the retracted position of the core wire 112 and a second location corresponding to the extended position of the core wire 112. The first location of the connector 98 is approximately 180 degrees from the second location of the connector 98. The core wire 112 moves between the retracted position and the extended position during the actuating cycle.

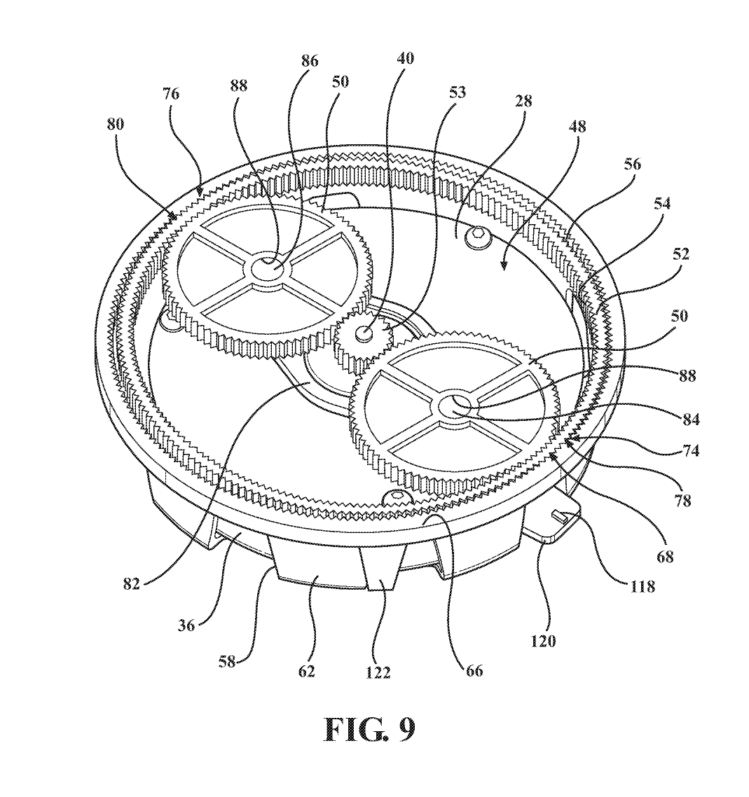

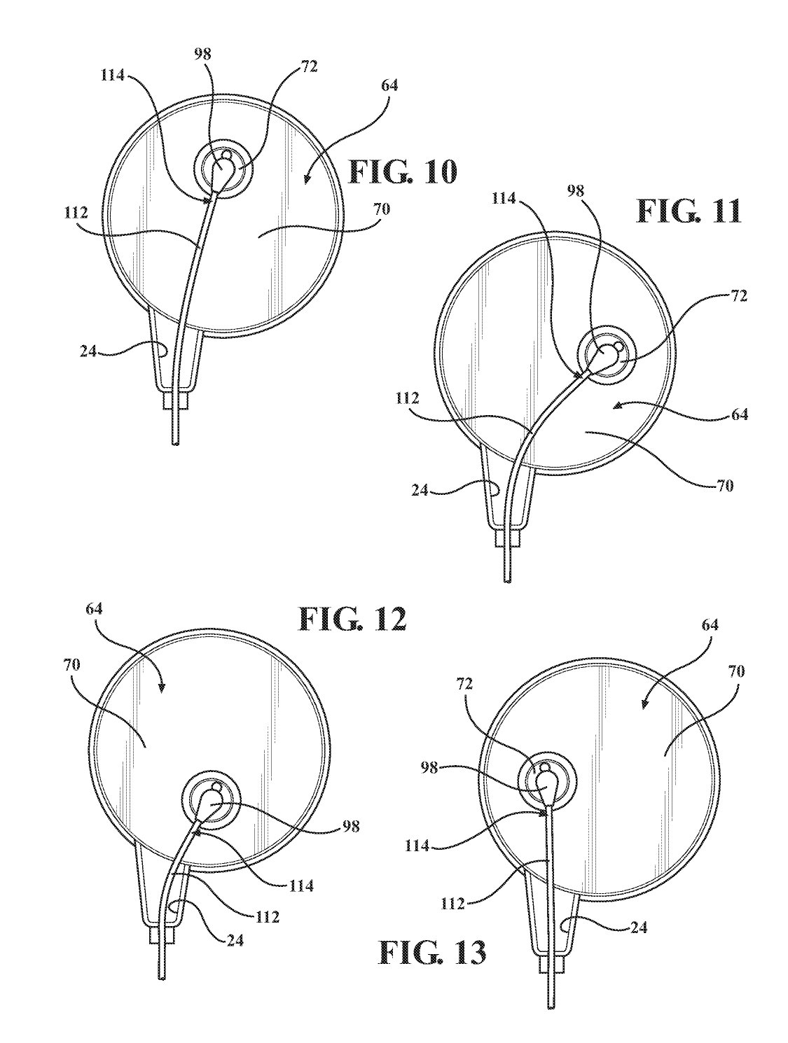

With reference to FIGS. 10-13, the actuating device 20 is shown in various positions in the actuating cycle. FIG. 12 shows the connector 98 of the actuating device 20 in the first location. As mentioned above, the first location of the connector 98 corresponds to the retracted position of the core wire 112. When the core wire 112 is in the retracted position, the seat-back latch is in a locked position. As current is supplied to the plurality of coils 38 of the printed circuit board 36, the connector 98 rotates with the output member 64 such that the connector 98 is in a position as shown in FIG. 13.

FIG. 13 shows the connector 98 of the actuating device 20 between the first location and the second location. When the connector 98 is in the position as shown in FIG. 13, the core wire 112 is moving from the retracted position toward the extended position. As the core wire 112 moves from the retracted position toward the extended position during the movement of the connector 98 with the rotation of the output member 64, the seat-back latch may begin to actuate.

FIG. 10 shows the connector 98 of the actuating device 20 in the second location. As mentioned above, the second location of the connector 98 corresponds to the extended position of the core wire 112. When the core wire 112 is in the extended position, the seat-back latch actuates to an unlocked position.

FIG. 11 shows the connector 98 of the actuating device 20 between the second location and the first location. When the connector is in the position as shown in FIG. 11, the core wire 112 is moving from the extended position toward the retracted position. When the core wire 112 moves from the extended position toward the retracted position, the seat-back latch is moving toward the locked position. To complete the actuating cycle, the connector 98 returns to the first location, as shown in FIG. 12.

In one embodiment, the output member 64 is rotatable in only one direction relative to the housing 22 during the actuating cycle. In this embodiment, the need for return springs or any other return mechanism are not needed as the connector 98 returns to the first position after rotation of output member 64 and actuation of the core wire 112. It is to be appreciated that the output member 64 may rotate in more than one direction, and the output member 64 may rotate anywhere between zero to 360 degrees without departing from the nature of the present invention.

In another embodiment, the actuating device 20 includes a sensor 118 disposed within the interior of the housing 22 for determining rotation of the output member 64. The printed circuit board 36 has a platform 120 extending outwardly and disposed between the flex gear 52. The sensor 118 is rigidly coupled to the housing 22 such that the sensor 118 remains stationary relative to the output member 64 for measuring 360 degree rotation of the output member 64 during the actuation cycle. More specifically, the sensor 118 is disposed on the platform 120 for determining rotation of the output member 64. The output member 64 has a finger 122 extending from the drive portion 66 toward the sensor 118. The finger 122 is disposed between the housing 22 and the flex gear 52. In one embodiment the sensor 118 is a magnetic activated sensor; however, it is to be appreciated that the sensor may be any type of sensor without departing from the nature of the present invention.

The actuating device also comprises an emitter 124 mounted on the output member 64 for interfacing with the sensor 118 during the actuating cycle. More specifically, the emitter 124 is mounted to the finger 122 of the output member, as best shown in FIG. 6. The emitter 124 and the sensor 118 interact such that rotation of the output member 64 stops once the output member 64 completes the actuation cycle.

As briefly mentioned above, to release the seat-back latch, current is supplied to the printed circuit board 36. The alternatively polarized magnets 33 of the rotor 32 rotate the shaft 40 of the motor assembly 26 due to the magnetic field formed by the current flowing to the printed circuit board 36. Since the rotor 32 is coupled to the shaft 40, rotation of the rotor 32 causes rotation of the shaft 40. Rotation of the shaft 40 causes the pinion 53 to rotate. Rotation of the pinion 53 causes the at least two planetary gears 50 to rotate. The rotation of the planetary gears 50 causes the planetary gears 50 to engage with the flex gear 52. Since the flex gear 52 is fixed to the housing 22, the planetary gears 50 pivot and rotate about the shaft 40 when the pinion 53 is rotating. The gear retainer 82 also pivots about the shaft 40 during the rotation of the pinion 53, which causes the planetary gears 50 to remain engaged with the inner surface 54 of flex gear 52 at the first area 74 and second area 76.

The pivoting of the planetary gears 50 about the shaft 40 causes the flex gear 52 to interact with the output member 64. More specifically, the outer surface 56 of the flex gear 52 engages the drive portion 66 of the output member 64 at the first section 78 and the second section 80 of the output member 64. As mentioned above, the first section 78 corresponds with the first area 74 and the second section corresponds with the second area 76 such that the first area 74 and the first section 78 are approximately 180 degrees from the second area 76 and the second section 80. The first section 78, the first area 74, the pinion 53, the second section 80, and the second area 76 are aligned linearly such that the outer surface 56 of the flex gear 52 remains engaged with the drive portion 66 of the output member 64 during rotation of the planetary gears 50 about the shaft 40 of the motor assembly 26.

The rotation of the planetary gears 50 causes the output member 64 to rotate about the shaft 40 due to the flex gear 52 being fixed to the housing 22. More specifically, since the second plurality of teeth of the flex gear 52 is less than the third plurality of teeth of the drive portion 66 of the output member 64 and because the flex gear 52 is fixed to the housing 22, the output member 64 rotates about the shaft 40. The rotation of the output member 64 causes the connector 98 to pull the core wire 112 further into the interior of the housing 22, thereby releasing the seat-back latch. After the seat-back latch is actuated due to the core wire 112 being pulled further into the interior of the housing 22 by the connector 98 with the connector 98 being in the second location, as shown in FIG. 10, the shaft 40 continues to rotate until the emitter 124 of the output member 64 returns to the sensor 118, therefore completing the actuating cycle.

The invention has been described in an illustrative manner, and it is to be understood that the terminology that has been used is intended to be in the nature of words of description rather than of limitation. Many modifications and variations of the present invention are possible in light of the above teachings, and the invention may be practiced otherwise than as specifically described.

1. An actuating device for actuating a cable, said actuating device comprising:
a housing defining an interior;
a motor assembly including a shaft with said motor assembly disposed within said interior of said housing;
at least two planetary gears disposed within said interior of said housing with said at least two planetary gears coupled to said motor assembly;
a flex gear disposed within said interior of said housing with said flex gear having an inner surface and an outer surface with said inner surface partially engaged with said planetary gears;
an output member at least partially disposed within said interior of said housing with said output member having a drive portion and a mounting interface with said drive portion engaged with a section of said outer surface of said flex gear such that said output member is rotatable relative to said housing when said shaft of said motor assembly rotates; and
a connector coupled to said mounting interface of said output member for securing the cable to said mounting interface with said connector moving relative to said housing and said mounting interface while moving in unison with said output member during said rotation of said output member for activating the cable during operation of the actuating device.

2. The actuating device as set forth in claim 1 wherein said flex gear comprises an elastically deformable material.

3. The actuating device as set forth in claim 2 wherein said flex gear has a base and a gear wall with said base rigidly fixed to said housing.

4. The actuating device as set forth in claim 2 wherein said flex gear defines a plurality of voids.

5. The actuating device as set forth in claim 3 wherein said gear wall of said flex gear has a rest state with said gear wall disengaged with said planetary gears, and an engaged state with said gear wall engaged with said planetary gears with said rest state having a first diameter and said engaged state having a second diameter with said second diameter greater than said first diameter.

6. The actuating device as set forth in claim 1 further comprising a gear retainer rotatably coupled to said housing with each of said planetary gears mounted to said gear retainer such that said planetary gears are rotatable relative to said housing about said inner surface of said flex gear when said shaft of said motor assembly rotates.

7. The actuating device as set forth in claim 5 wherein said inner surface of said flex gear is further defined as a first area and a second area approximately 180 degrees from said first area along said inner surface with one of said planetary gears engaged with said first area and the other one of said planetary gears engaged with said second area, and wherein said section of said outer surface of said flex gear is further defined as a first section and a second section approximately 180 degrees from said first section along said outer surface with said first area corresponding to said first section and said second area corresponding to said second section with said first and second sections of said outer surface engaged with said drive portion of said output member, thereby defining said second diameter such that said gear wall of said flex gear remains in said engaged state during said operation of said actuating device.

8. The actuating device as set forth in claim 1 wherein said planetary gears have first plurality of teeth, said outer surface of said flex gear has a second plurality of teeth, and said drive portion of said output member has a third plurality of teeth with said second plurality of teeth being greater than said first plurality of teeth and said third plurality of teeth being greater than said second plurality of teeth.

9. The actuating device as set forth in claim 1 further comprising a sensor disposed within said interior of said housing for determining rotation of said output member.

10. The actuating device as set forth in claim 9 wherein said sensor is a magnetic activated sensor.

11. The actuating device as set forth in claim 9 wherein said output member has a finger extending from said drive portion toward said sensor with said finger being disposed between said housing and said flex gear.

12. (canceled)

13. The actuating device as set forth in claim 1 wherein said motor assembly is a pancake motor comprising a casing defining an interior, and a flux plate, a printed circuit board, and a rotor disposed within said interior of said casing with said printed circuit board disposed between said rotor and said flux plate.

14. The actuating device as set forth in claim 13 wherein said shaft is coupled to said rotor of said pancake motor.

15. The actuating device as set forth in claim 14 wherein said pancake motor further comprising a coupler disposed within the interior of said casing of said pancake motor with said coupler mounted to said rotor and said shaft such that rotation of said rotor transmits rotation to said shaft.

16. The actuating device as set forth in claim 13 wherein said printed circuit board has a platform extending outwardly and disposed between said flex gear with said actuating device further comprising a sensor disposed on said platform for determining rotation of said output member.

17. The actuating device as set forth in claim 1 wherein said mounting interface of said output member has a segment elevated toward said housing with said connector coupled to said segment of said mounting interface.

18. The actuating device as set forth in claim 1 wherein said housing has a first half adjacent the output member and a second half adjacent the flex gear with said second half having a shelf and said first half having a protrusion extending toward said shelf and wherein said output member has a ledge disposed between said shelf and said protrusion.

19. An actuating device comprising:
a housing defining an interior;
a motor assembly including a shaft with said motor assembly disposed within said interior of said housing;
a gear system disposed within said interior of said housing with said gear system coupled to said motor assembly;
an output member at least partially disposed within said interior of said housing with said output member engaged with said gear system and rotatable relative to said housing during operation of said motor assembly;
a cable having a conduit and a core wire moveable within said conduit between a retracted position and an extended position with said core wire having first and second opposing ends; and
a connector coupled to said output member with said first end of said cable coupled to said connector and moveable 360 degrees during said rotation of said output member to define an actuating cycle with said connector having a first location corresponding to said retracted position of said core wire and a second location corresponding to said extended position of said core wire with said first location approximately 180 degrees from said second location with said core wire moving between said retracted and said extended positions during said actuating cycle.

20. The actuating device as set forth in claim 19 wherein said output member is rotatable in only one direction relative to said housing during said actuating cycle.

21. The actuating device as set forth in claim 19 wherein said output member has a drive portion and a mounting interface with said drive portion engaged with said gear system and said connector coupled to said mounting interface.

22. The actuating device as set forth in claim 19 further comprising a sensor rigidly coupled to said housing such that said sensor remains stationary relative to said output member for measuring 360 degree rotation of said output member during said actuation cycle.

23. The actuating device as set forth in claim 22 further comprising an emitter mounted on said output member for interfacing with said sensor during said actuation cycle.

24. The actuating device as set forth in claim 1 wherein said movement of said connector relative to said mounting interface is further defined as pivoting relative to said mounting interface as said connector moves in unison with said output member relative to said housing.
